(19) United States
(12) Patent Application Publication
(10) Pub. No.: US 2007/0136366 A1
(43) Pub. Date: Jun. 14, 2007

(54) METHOD AND SYSTEM FOR STRUCTURED OBJECT MODELING

(76) Inventor: SERGE BRIE, QUEBEC (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/530,196

(22) Filed: Sep. 8, 2006

Related U.S. Application Data
(60) Provisional application No. 60/725,658, filed on Oct. 13, 2005.

(51) Int. Cl. G06F 17/00

(52) U.S. Cl. 707/103 R

(57) ABSTRACT

A method for modeling classes to create an application in an object-oriented programming environment based on a hierarchical rooted classification (E) and inheritance-based naming of an entity is disclosed. The method comprising in the logic classification (EB), on a first level, determining whether the entity belongs to a single-element class (EBU) or a multiple-element class (EBG) and providing a first indication therefor; on a second level, if the entity belongs to a single-element class (EBU), determining whether the entity is one of a data (I), a link (L), a role (R) and a domain (D) and providing a second indication therefor; and creating a name for the entity by aggregating the first and the second indications. A method for modeling classes also based on exemplary class assembly models for behavior such as group, role and transaction is also disclosed. There is also disclosed a method for creating pseudo-code comprising: creating classes according to the method for modeling classes as disclosed above; creating a class assembly model for each model/package-group class; assembling said classes into package-group classes according to said model/package-group classes; and creating pseudo-code from said classes.

### FIELD OF THE INVENTION

The invention relates to the field of programming languages and computer management of logical entities such as objects/classes.

### BACKGROUND OF THE INVENTION

There exists a need for a comprehensive tool allowing to represent, as close as possible, reality and logic in classes.

With prior art systems, the organization of an object-oriented architecture is highly dependent upon the programmer's expertise level. With currently available tools, it is difficult to create objects/classes of a chosen domain. Furthermore, none of the currently available classification systems allow structured creation and naming of all the classes necessary to a given application.

Other difficulties associated with currently available systems include: the difficulty in uniquely naming classes since existing software does not provide any nomenclature rules that makes it easy for a programmer not familiar with the architecture of a system to follow. As a system is being developed and grows in complexity, it becomes harder to maintain a certain consistency in naming of different classes.

Another drawback associated with prior art systems is the difficulty in separately representing a class and its activities. It is common practice therefore to create different classes to represent the same reality, e.g. client, supplier, etc.

It is also difficult to represent the cardinality of a set of objects/classes, since multiplicity is a property that can only be used to characterize links between classes.

Furthermore, with current tools, classes need to be assembled into packages in order to build an architecture. While some current systems provide tools for class creation, these are poorly adapted to describe logical associations between classes.

There are further difficulties in defining packages expressing a dynamic view of an application by associating different classes expressed in a static view.

There are also difficulties in coherently naming packages, as well as certain components such as interfaces and databases.

There are therefore numerous difficulties in imparting knowledge regarding the classes and their associations to other programmers.

### SUMMARY

The modeling method according to an embodiment of the present invention comprises a hierarchical rooted classification method including a method of naming classes according to inheritance principles.

A generated model classification class (EM) represents the concept of a model. Within the model classification hierarchy, a model/package-group class (EM_GpEB) represents a logical class assembly model, built around a logic classification class (EB), for implementation in package-group class (EBGp). Furthermore, in an example, model/package-group classes for single-element classes (EBU) and multiple-element classes (EBG) are provided within the hierarchy.

Within a generated logic classification class (EB) hierarchy, both single-element classes (EBU) and multiple-element classes (EBG) can be organized into logic families. The families of single-element class (EBU) include domain class (EBUD), link class (EBUL), role class (EBUR) and data class (EBUI). The families of multiple-element class (EBG) include associative-group class (EBGa), inheritance-group class (EBGh), family-group class (EBGf) and package-group class (EBGp).

Furthermore, the exemplary concepts represented by the above classes facilitate their logical associations in order to represent better and separately any class and its behaviour

The naming method according to an embodiment of the present invention facilitates the maintenance of a coherent “name space” since it allows the creation of class names providing information regarding the logic family to which a class belongs, as well as references to other classes.

The modeling method according to an embodiment of the present invention further comprises, in another aspect, a method for associating classes into class assembly models according to exemplarily concepts such as role, group and transaction. Such class assembly models are implemented in model/package-group classes (EM_GpEB).

In still another aspect, the inherent logic of the classification, the naming method and class assembly method according to an embodiment the present invention, further facilitate pseudo code creation.

In order to achieve a logical and coherent approach for class creation within an application, an embodiment of the present invention allows creation and naming of each class within a hierarchical rooted classification including classes representing a logical assembly of classes such as class assembly models and packages.

According to an embodiment, there is provided a method for modeling classes to create an application in an object-oriented programming environment based on a hierarchical rooted classification (E) and inheritance-based naming of an entity. The method comprising, in the logic classification (EB), on a first level, determining whether the entity belongs to a single-element class (EBU) or a multiple-element class (EBG) and providing a first indication therefor; on a second level, if the entity belongs to a single-element class (EBU), determining whether the entity is one of a data (I), a link (L), a role (R) and a domain (D) and providing a second indication therefor; and creating a name for the entity by aggregating the first and the second indications.

According to another embodiment, the method for modeling classes further comprises if said entity represents a multiple-element class (EBG), determining whether said multiple-element class is one of: a family group (f) in which all elements are implemented objects from classes descendant from the same hierarchical class; an inheritance group (h) in which all elements are implemented objects from the same class; an associative group (a), in which elements belong to different classes; and a package group (p) in which elements are part of a logical class assembly.

According to another embodiment, there is provided a method for creating pseudo-code comprising: creating classes according to the method for modeling classes as disclosed above; creating a class assembly model for each model/package-group class; assembling said classes into package-group classes according to said model/package-group classes; and creating pseudo-code from said classes.

### BRIEF DESCRIPTION OF THE DRAWINGS

These and other features aspects and advantages of the present invention will become better understood with regard to the following description and accompanying drawings wherein:

FIG. 1 is a block diagram of a hierarchical structure of classes according to an embodiment of the classification method of the present invention;

FIG. 2 is a block diagram of a hierarchical structure of single-element domain classes according to an embodiment of the classification method of the present invention;

FIG. 3 is a block diagram of a hierarchical structure of single-element data classes according to an embodiment of the classification method of the present invention;

FIG. 4 is a block diagram of a hierarchical structure of single-element link classes according to an embodiment of the classification method of the present invention;

FIG. 5 is a block diagram of a hierarchical structure of single-element role classes according to an embodiment of the classification method of the present invention;

FIG. 6 is a block diagram of a class assembly built around a logic classification class implementing the role concept to a model/package-group class according to an embodiment of the modeling method of the present invention;

FIG. 7 is a block diagram of a class assembly built around a multiple-element class implementing the group concept to a model/package-group/multiple-element class according to an embodiment of the modeling method of the present invention;

FIG. 8 is block diagram of a hierarchical structure of model classification classes according to an embodiment of the classification method of the present invention;

FIG. 9 is a block diagram of a class assembly built around a single-element class implementing the role concept to a model/package-group/single-element class according to an embodiment of the modeling method of the present invention;

FIG. 10 is a block diagram of a class assembly built around a transaction class implementing the transaction concept to a model/package-group/transaction class according to an embodiment of the modeling method of the present invention;

FIG. 11 is a block diagram of a class assembly built around an associative-group class implementing the role and group concept to a model/package-group/associative-group class according to an embodiment of the modeling method of the present invention;

FIG. 12 is a block diagram of a class assembly built around an inheritance-group class implementing the role and group concept to a model/package-group/inheritance-group class according to an embodiment of the modeling method of the present invention;

FIG. 13 is a flow chart of a method for code generation according to an embodiment of the present invention; and

FIG. 14 is a flow chart of a method for hierarchical classification and inheritance-based naming of an entity according to an embodiment of the present invention.

### DETAILED DESCRIPTION

The rooted hierarchic classification method according to an embodiment of the present invention provides a structural base from which all classes necessary to an application can be easily declared and classified according to inheritance principles. The classification method further allows for inheritance-based naming of an entity according to its place within the hierarchical classification, as well as with respect to other referenced classes.

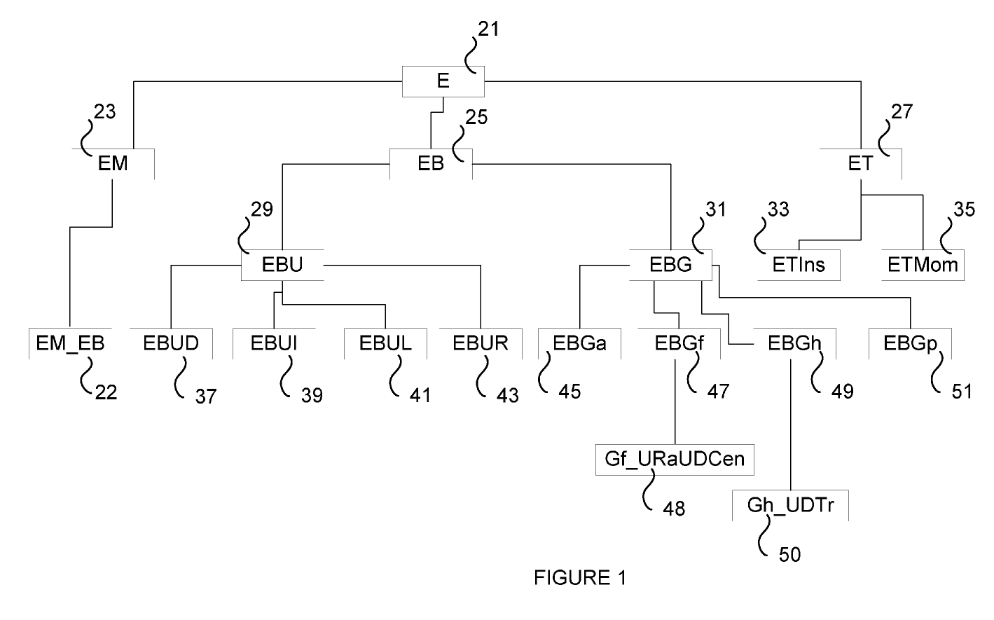

With respect to FIG. 1, there is provided a root element class (E) 21 from which all other classes are derived. The hierarchical classification method according to an embodiment of the present invention provides for the possibility of modeling classes according to different logical classifications of entities. For example, all classes (EB) 25 are part of a logic classification. All classes (EM) 23 are part of a model classification, while classes (ET) 27 are time elements, including the final-classes (ETIns) 33 for instants and (ETMom) 35 for moments.

Within model classification class (EM) 23 hierarchy, generated class (EM_EB) 22 represents the model for implementation of a logic classification class (EB) 25.

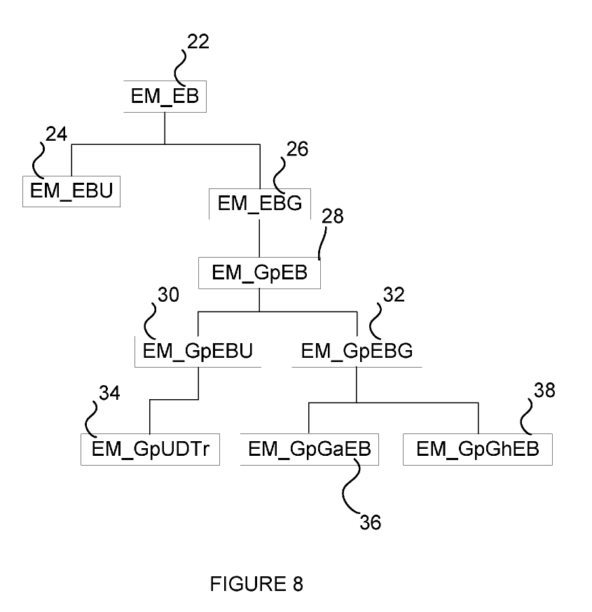

As shown in FIG. 8, Class (EM_EB) 22 generates model/single-element class (EM_EBU) 24 and model/multiple-element class (EM_EBG) 26. Further generated from model/multiple-element class (EM_EBG) 26 is exemplarily model/package-group class (EM_GpEB) 28 which generates model/package-group/single-element class (EM_GpEBU) 30 and model/package-group/multiple-element class (EM_GpEBG) 32.

Still further, exemplarily classes can be classified as model/package-group/transaction class (EM_GpUDTr) 34, model/package-group/associative-group class (EM_GpGaEB) 36 and model/package-group/inheritance-group class (EM_GpGhEB) 38.

Returning to FIG. 1, within logic classification class (EB) 25, classes can further be generated according to whether they are single-element class (EBU) 29 or multiple-element class (EBG) 31. A single-element class is a class that may be used to define a single entity. A multiple-element class is a class that may be used to define a composite entity, such as a group of entities.

Still with respect to FIG. 1, at a next level within the hierarchical classification structure, the single-element classes (EBU) 29 may be further classified. For example, a single-element class can generate a domain class (EBUD) 37, which represents a logical, a physical or a virtual element of the domain of activity. The concept of domain is analogous to that of “object” in traditional object-oriented programming. Examples of single-element classes are classes used to describe entities such as: a product, a commercial entity, a transaction, a register, etc.

Single-element class (EBU) 29 can also generate a logical link class (EBUL) 41, which can be used to model a link in a contextual class association, e.g., the relationship between a class and its role, the inheriting relationship between classes or the relationship between a class and the group to which it belongs. Examples of single-element link classes are therefore link role, link inheritance, link group, etc. A link class exposes a contextual class association.

Another type of generated single-element class is a logical role class (EBUR) 43, which is used to represent the role imparted to a given class and serve to dissociate a class from its role; i.e., what a thing is and what it does are represented by different classes. Examples of single-element role classes include activities such as seller and buyer.

Also generated are virtual data classes (EBUI) 39 for representing computer tools. This representation provides, in the model, the data necessary to the application; e.g., data, state, function, interface.

Still with respect to FIG. 1, generated multiple-element classes will be described. These include, for example, associative-group class (EBGa) 45 which is for representing assemblies of classes not represented by other multiple-element classes.

Another multiple-element class is the family-group class (EBGf) 47 which is a class representing a set of implemented objects from classes originating from a same hierarchical class. In a same class (EBGf) 47, for example, a project management role and a human resources role may be grouped as enterprise roles. Example class (Gf_URaUDCen) 48 is shown and will be further discussed below.

Still another multiple-element class is the inheritance-group class (EBGh) 49 which is a class for representing a set of implemented objects from a same class. For example, a group of all commercial entities or a group of all link roles for project resources are classes (EBGh) 49. Example class (Gh_UDTr) 50 is shown and will be further discussed below.

Yet another multiple-element class is the package-group class (EBGP) 51 which is a class representing the implementation of a class assembly model from a model/package-group class (EM_GpEB) 32.

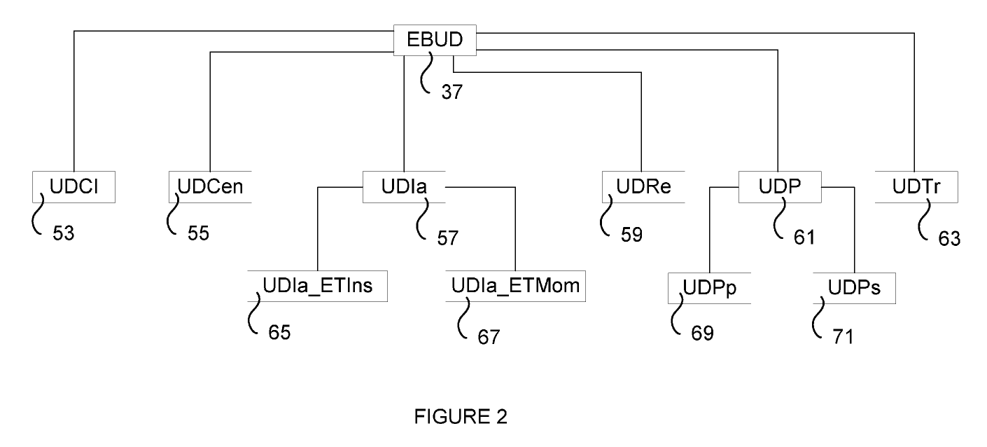

Now, with respect to FIG. 2, classes corresponding to the families described hereinabove will be described. In the domain class (EBUD) 37, there are provided the following exemplary classes: classification class (UDCI) 53, commercial entity class (UDCen) 55, interval class (UDIa) 57, product class (UDP) 61, register class (UDRe) 59 and transaction class (UDTr) 63.

The product class (UDP) 61 is a parent class to child classes (UDPP) 69 for a physical product and (UDPs) 71 for a service product.

The transaction class (UDTr) 63 plays an important role in representing a class common to two different activity assemblies (such as buying and selling, for example). Indeed, a (UDTr) 63 class allows to link logically different package-group classes implemented in an application.

Finally, as shown in FIG. 2, the interval class (UDIa) 57 is a parent to the instant interval class (UDIa_ETIns) 65 and the moment interval class (UDIa_ETMom) 67.

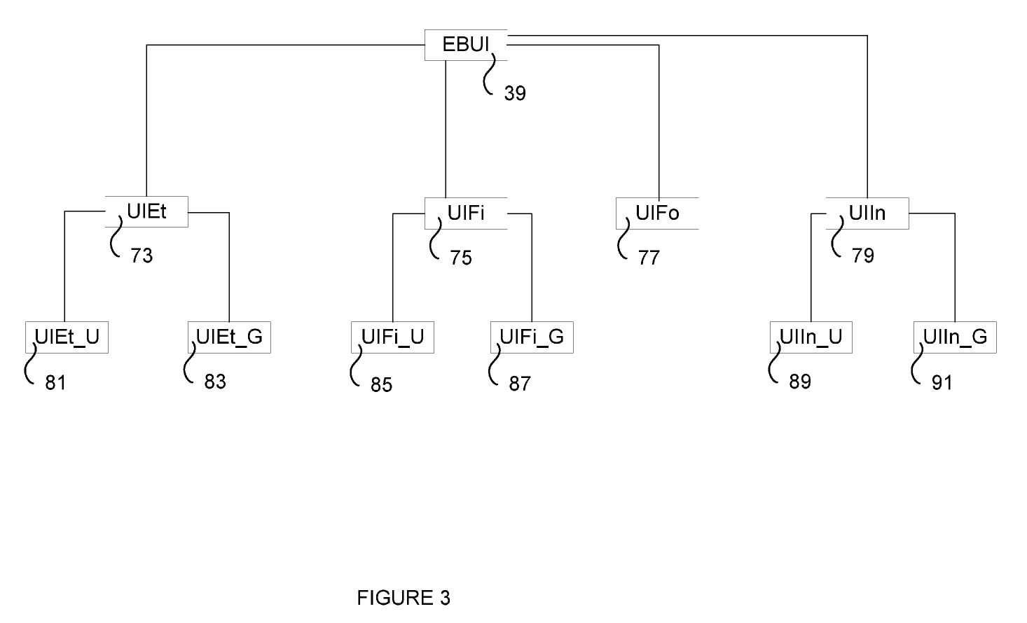

Now, with respect to FIG. 3, exemplary data class (EBUI) 39 will be described. Classes that may be generated within the class (EBUI) 39 hierarchy include: state class (UIEt) 73, file class (UIFi) 75, function class (UlFo) 77 and interface class (UIIn) 79. Some of these classes can be used as building blocks for creating classes including their reference to a single-element class (81, 85 and 89) or a multiple-element class (83, 87 and 91).

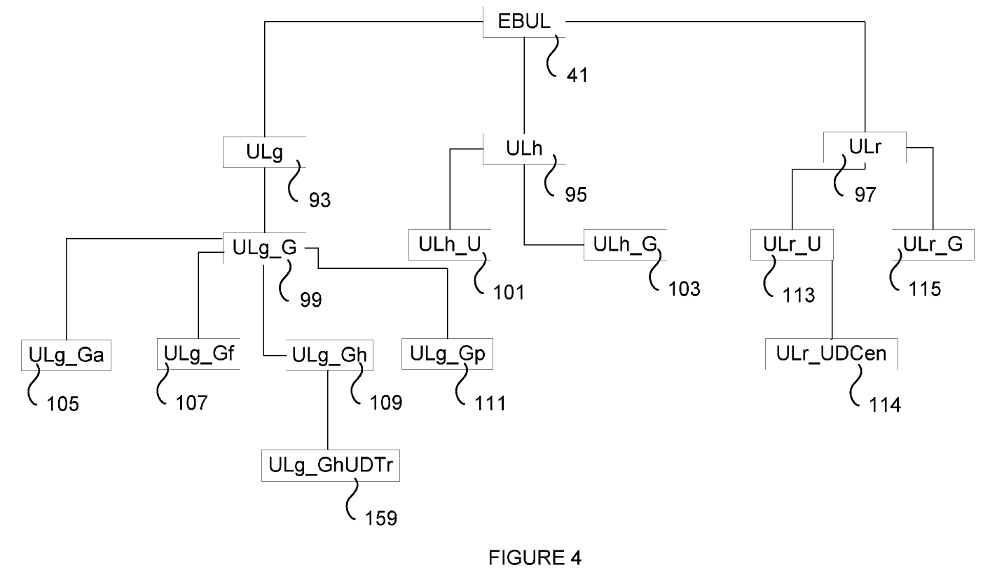

In FIG. 4, there is shown exemplary link class (EBUL) 41, used for representing link classes. Classes of the type link-group class (ULg) 93 are used to build group behavior in class assembly and generate link-group/multiple-element class (ULg_G) 99. Further generated classes may be one of a link-group/associative-group class (ULg_Ga) 105, a link-group/family-group class (ULg_Gf) 107, a link-group/inheritance-group class (ULg_Gh) 109 and a link-group/package-group class (ULg_Gp) 111. Exemplarily, link-group/inheritance-group/transaction class (ULg_GhUDTr) 159 is also generated.

Still, with respect to FIG. 4, classes of the type link-inheritance class (ULh) 95 are used to build inheritance link classes. These might be inheritance links for single-element classes (ULh_U) 101 or multiple-element classes (ULh_G) 103.

Classes of type link-role (ULr) 97 are used to build role behavior in class assembly i.e. to link a class to its role. In fact, a link-role class exposes what a class is as well as which role it plays. Again, as for other class types, these may be links for single-element classes (ULr_U) 113 or multiple-element classes (ULr_G) 115. Example class (ULr_UDCen) 114 is shown and will be further discussed below.

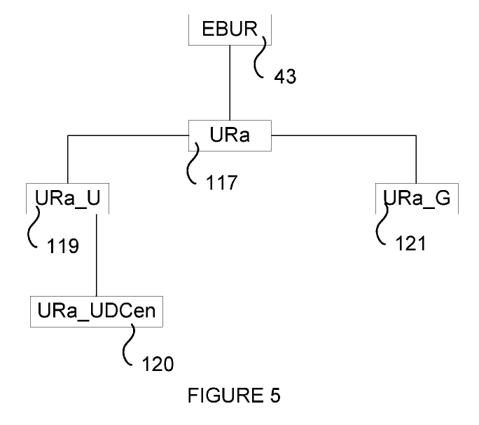

Now, with respect to FIG. 5, there are shown single-element classes used for representing role classes, i.e. of the type role class (EBUR) 43. Exemplarily classes of the type (URa) 117are used to describe a type of role. Again, as for other class types, generated classes may be defined with reference to single-element classes (URa_U) 119 or multiple-element classes (URa_G) 121. Example class (URa_UDCen) 120 is shown and will be further discussed below.

While not shown in the appended drawings, the multiple-element classes (EBGf) 47 and (EBGh) 49, may each be used for creating a class grouping a plurality of implemented objects from either a single-element class or a multiple-element class, designated with the usual “_U” or “_G” notation respectively. Also not shown, the multiple-element classes (EBGa) 45 and (EBGP) 51 may each be used to represent class assemblies for either single-element classes or multiple-element classes, designated with the usual “_U” or “_G” notation, respectively.

As can be seen from the classification method described above, an embodiment of the present invention may be used for implementing a naming method representative of the hierarchical position of a class in the classification, as well as of its reference to another class. In the context of application development, the naming method may be used for creating a coherent library of class names for the whole system. The naming method therefore provides a basis from which all entities necessary in an application can be named in a unique manner. The inheritance naming method provides for child classes incorporating the name of the parent classes, as well as the names of other referenced classes.

The syntax of the naming method is based on several principles that include use of one-letter abbreviations to represent upper-level classes, use of two-letter abbreviations for intermediate-level classes, use of three-letter abbreviations for final classes and the use of the underscore character “_” in order to indicate class references.

The aggregation of the letters and characters may be read by separating the elements starting by the letters U or G.

The following are examples of entity names created according to an embodiment of the present invention.

(Gh_UDTr) 50 (see FIG. 1) is a name for a multiple-element inheritance-group class (EBGh) 49 of a set of implemented objects from a single-element domain transaction class (UDTr) 63.

(URa_UDCen) 120 (see FIG. 5) is a name for a single-element role class (URa) 117 used to impart an activity to a single-element domain commercial entity class (UDCen) 55.

(Gf_URaUDCen) 48 (see FIG. 1) is a name for the multiple-element family-group class (EBGf) 47 of a set of implemented objects from classes descendant from a single-element role class (URa) 117 imparted to a single-element domain commercial entity class (UDCen) 55.

(ULr_UDCen) 114 (see FIG. 4) is a name for a single-element link-role class (ULr) 97 used to impart a role to a single-element domain commercial entity (UDCen) 55.

An embodiment of the present invention comprises, in a second aspect, an easy and improved method of associating classes. Exemplarily behaviour concepts such as role, group and transaction are embodied in class assembly construct. Such constructs are implemented in the model/package-group classes required by the application. In effect, behavior for any given class of the classification may then be represented by a logical class assembly model built around that class.

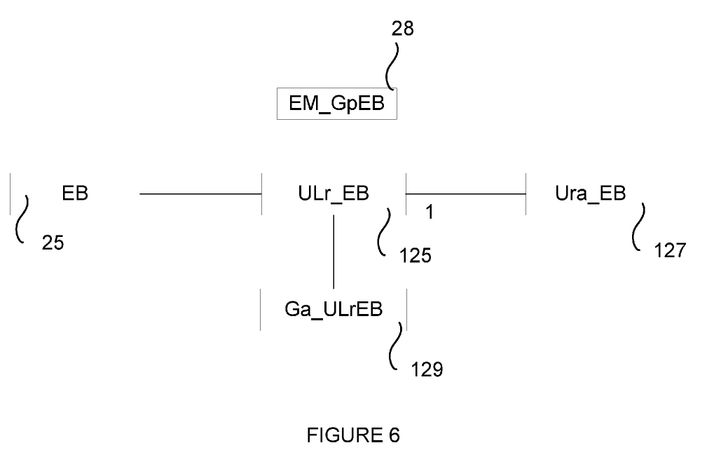

With respect to FIG. 6, there is shown an exemplary implementation of the concept of role construct to a model/package-group class (EM_GpEB) 28. Within the class assembly model, class (EB) 25 represents the target class to which the role, represented by role class (URa_EB) 127, is associated. The class (EB) 25 may be a single-element or a multiple-element class. Such a class (EB) 25 is associated to link-role class (ULr_EB) 125. The class (ULr_EB) 125 is the link for a particular role. Finally, the associative-group/link-role class (Ga_ULrEB) 129 is a multiple-element class assembling related classes and providing parameters for the class (EB) 25 and the associated role class (URa_EB) 127.

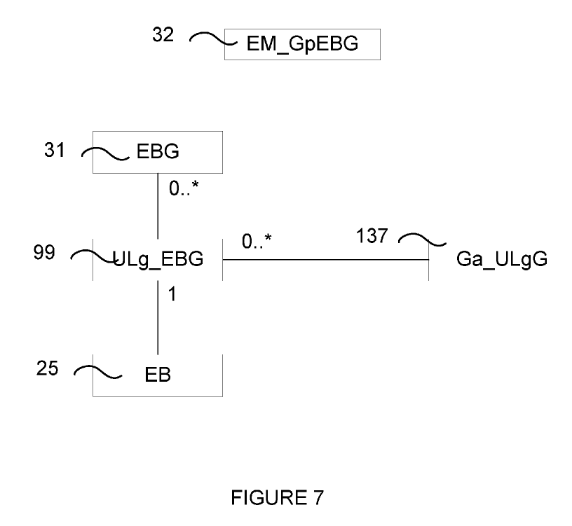

With respect to FIG. 7, there is shown another exemplary implementation of the concept of a group construct to a model/package-group/multiple-element class (EM_GpEBG) 32. Within the class assembly model, class (EBG) 31 represents any type of multiple-element class (i.e., may take on any of the Ga, Gf, Gh or Gp values). Class (ULg_G) 99 represents a link group for associating an object of class (EB) 25 to multiple-element class (EBG) 31. It is useful to stipulate that a class (EBG) 31 may be connected to a plurality of objects of the class (EB) 25, but each link is for a single object of the class (EB) 25 at a time. Finally, the associative-group/link-group/multiple-element class (Ga_ULgG) 137 represents a multiple-element class assembling related classes and providing information specific to the assembly.

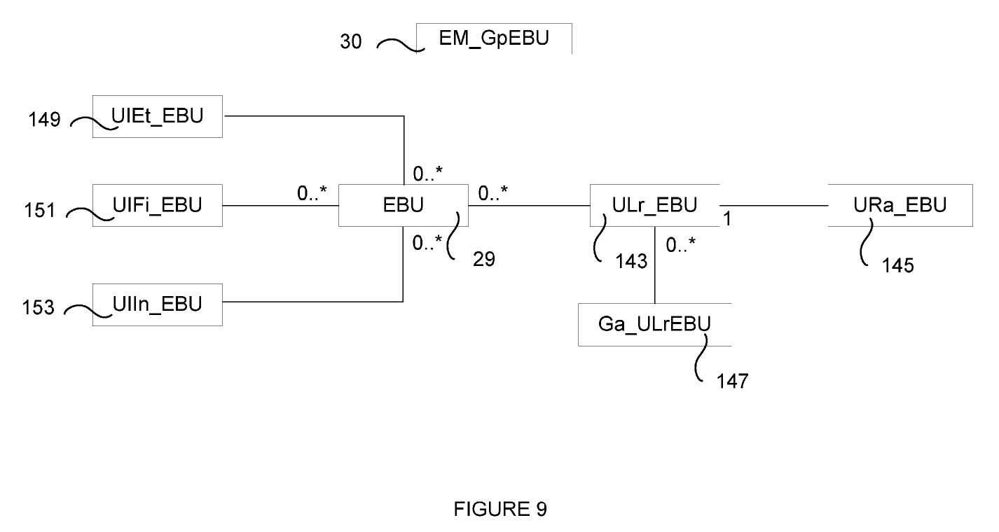

FIG. 9 represents an implementation of a class assembly model to a model/package-group/single-element class (EM_GpEBU) 30, based on the class assembly model of FIG. 6. Classes 149, 151 and 153 are data element classes, representing a state class, file class and interface class respectively associated to the single-element class (EBU) 141.

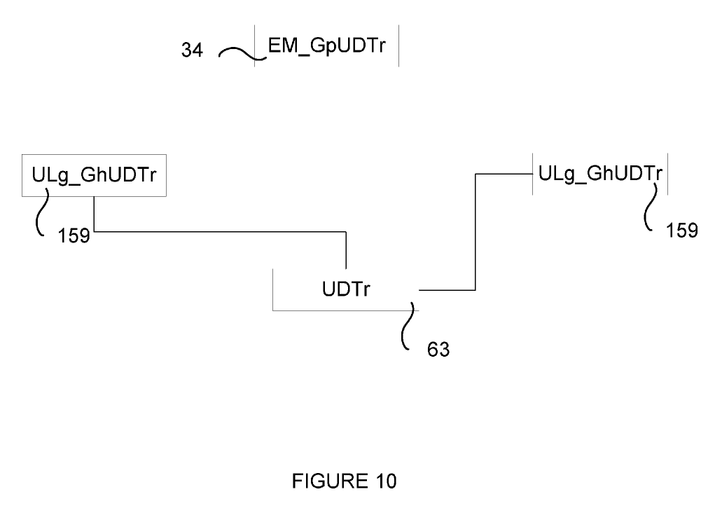

FIG. 10 represents an implementation of the concept of a transaction construct to a model/package-group/transaction class (EM_GpUDTr) 34. Within the class assembly model, transaction class (UDTr) 155 may belong to a minimum of two link-group/inheritance-group/transactions classes (ULg_GhUDTr) 159 representing logical senders and receivers. In effect, a transaction class (UDTr) 155 permits multiple inheritance-group/transaction classes (Gh_UDTr) 50 ownership; each may be associated in class assembly of different package-group classes.

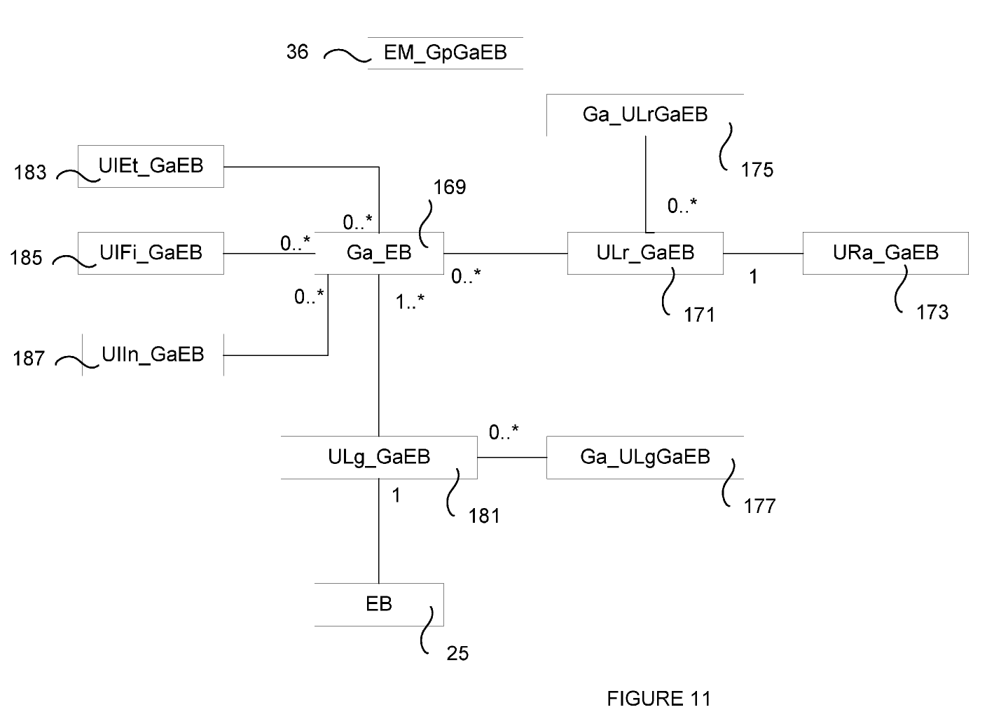

FIG. 11 represents an implementation of a class assembly model to model/package-group/associative-group class (EM_GpGaEB) 36 based on the class assembly model of FIG. 6 and the class assembly model of a multiple-element class of FIG. 7. In FIG. 11, it is useful to stipulate that objects of class (EB) 25 are different from objects of the model and of the objects of class (EB) 25 referenced in associative-group class (Ga_EB) 169. Classes 183, 185 and 187 are data element classes, representing a state class, file class and interface class respectively associated to the associative-group class (Ga_EB) 169.

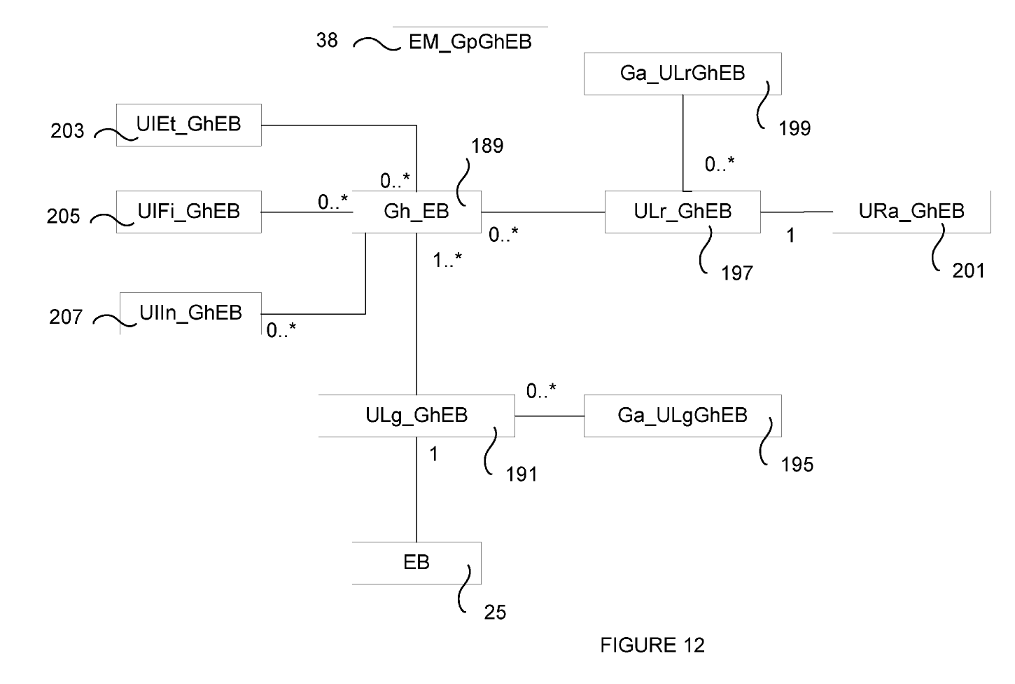

FIG. 12 represents an implementation of a class assembly model to model/package-group/inheritance-group class (EM_GpGhEB) 38 based on the class assembly model of FIG. 6 and the class assembly model of a multiple-element class of FIG. 7. In FIG. 12, all class (EB) 25 objects are objects from the same parent class.

The implementation according to an embodiment the present invention requires creating the appropriate classes within the classification and using model/package-group classes to assemble them in order to obtain the packages needed in a given application. The packages will be represented by a class of the multiple-element package-group class.

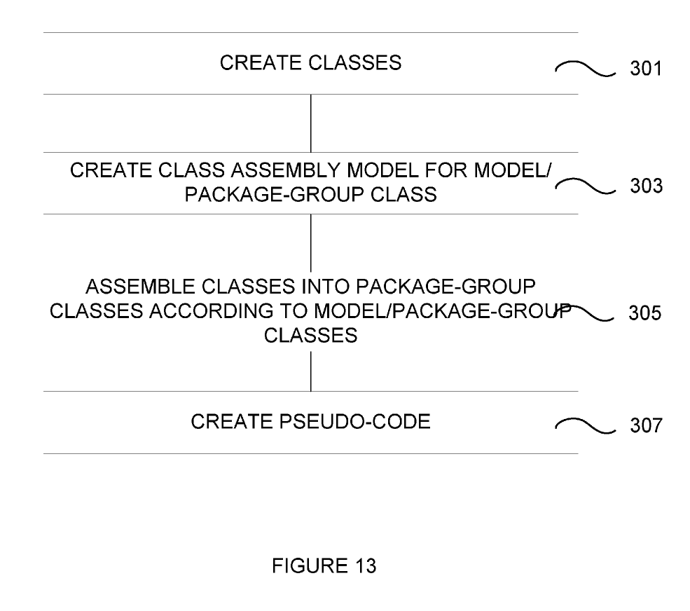

An embodiment of present invention also provides, as shown in FIG. 13, a method of creating pseudo-code. In step 301, classes are created according to the classification method that has been described hereinabove. In step 303, a class assembly model is created for each model/package-group class. In step 305, model/package-groups are used to assemble classes into package-group class according to model/package-group classes. Finally, in step 307, the pseudo-code is created featuring the advantages of the hierarchical rooted classification, the inheritance-based naming and the logical class assembly methods according to an embodiment of the present invention.

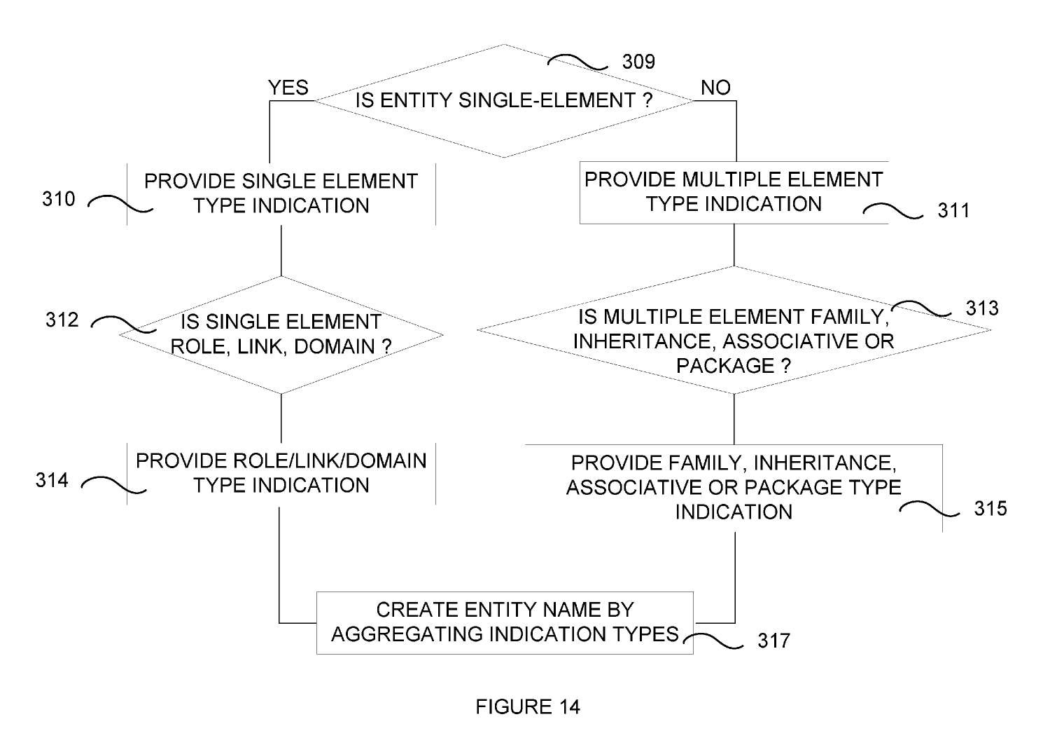

With respect to FIG. 14, there is shown a method for inheritance-based naming of a logic classification entity in an object-oriented environment according to an embodiment of the present invention. In step 309, an evaluation is made as to whether the entity is a single element. If so, in step 310, a single-element type indication is provided. Then, in step 312, an assessment is made as to whether the single element represents a role, a link, a domain or data. In step 314, an indication is provided appropriate to the type (role, link, domain, and data). Finally, in step 317, an entity name is created by aggregating all provided type indications. Similarly, if the entity is a multiple element, a multiple-element type indication is provided in step 311. Then, in step 313, it is determined whether the multiple-element is of the family, inheritance, associative or package type. In step 315, a type indication, such as family, associative, package, etc. is provided. Finally, in step 317, an entity name is created by aggregating the provided type indications.

What is claimed is:

1. A method for modeling classes to create an application in an object-oriented programming environment based on a hierarchical rooted classification (E) and inheritance-based naming of an entity, said method comprising:
in a logic classification (EB), on a first level, determining whether said entity belongs to a single-element class (EBU) or a multiple-element class (EBG) and providing a first indication therefor;
on a second level, if said entity belongs to a single-element class (EBU), determining whether said entity is one of a data (I), a link (L), a role (R) and a domain (D) and providing a second indication therefor; and
creating a name for said entity by aggregating said first and said second indications.

2. The method as in claim 1, further comprising:
on a third level, if said entity is a domain, determining whether said domain represents a virtual, logical or a physical entity, such as a transaction, a physical product, or a file, and providing a third indication therefor and wherein said name comprises said third indication.

3. The method as in claim 1, further comprising:
on a third level, if said entity is a data, determining whether said data represents a file, a database or an interface and providing a third indication therefor and wherein said name comprises said third indication.

4. The method as in claim 1, further comprising:
on a third level, if said entity is a link, determining whether said entity represents a link for a role, an inheritance or a group, and providing a third indication therefor and wherein said name comprises said third indication.

5. The method as in claim 1, further comprising:
on a third level, if said entity is a role, determining whether said entity represents an activity, and providing a third indication therefor and wherein said name comprises said third indication.

6. The method as in claim 1, further comprising, if said entity represents a multiple-element class (EBG), determining whether said multiple-element class is one of:
a family group (f) in which all elements are implemented objects from classes descendant from a same class;
an inheritance group (h) in which all elements are implemented objects from a same class;
an associative group (a), in which elements belong to different classes; and
a package group (p) in which elements are part of a logical class assembly.

7. The method as in claim 6, further comprising providing a fourth indication of a multiple-element class type and creating a name for said entity by aggregating said first and said fourth indications.

8. The method as claimed in claim 1, further comprising generating a model classification (EM) and the logic classification (EB) within the hierarchical rooted classification.

9. The method as claimed in claim 8, further comprising, within the model classification (EM) hierarchy, determining that a model/package-group class (EM_GpEB) represents a logical class assembly model, built around logic classification class (EB), and used in implementing a package-group class (EBGp) within said logic classification.

10. The method as claimed in claim 9, further comprising determining that the logical class assembly model comprises at least one of the concepts of role, group and transaction.

11. The method as claimed in claim 10, further comprising representing a behavior for any given class of the classifications by the logical class assembly model built around the given class.

12. The method as claimed in claim 9, further comprising using hierarchical classes in class assembly models.

13. The method as claimed in claim 9, further comprising allowing hierarchical child model/package-group class to inherit class assembly model from the class assembly model of the parent class.

14. The method as claimed in claim 1, further comprising allowing for inheritance-based naming of an entity according to its place within the hierarchical classification, as well as with respect to other referenced classes.

15. The method as claimed in claim 14, further comprising using one-letter abbreviations to represent upper-level classes, use of two-letter abbreviations for intermediate-level classes, use of three-letter abbreviations for final classes and using the underscore character “_” in order to indicate class references.

16. The method as claimed in claim 14, further comprising uniquely naming computer entities such as data, state, function and interface for the whole system.

17. A method for creating pseudo-code comprising:
creating classes according to the method for modeling classes as claimed in claim 9;
creating a class assembly model for each model/package-group class;
assembling said classes into package-group classes according to said model/package-group classes; and
creating pseudo-code from said classes.
